(19) United States
(12) Patent Application Publication
(10) Pub. No.: US 2011/0229123 A1
(43) Pub. Date: Sep. 22, 2011

(54) CROSS-DOMAIN PARALLEL RECOVERING METHOD AND SYSTEM IN MULTI-LAYER AND MULTI-DOMAIN DISTRIBUTED OPTICAL NETWORK

(76) Inventors: Hui Li, Beijing (CN); Yuefeng Ji, Beijing (CN); Yaojun Qiao, Beijing (CN); Xiye Li, Beijing (CN)

(21) Appl. No.: 13/129,706

(22) PCT Filed: Jul. 14, 2010
(86) PCT No.: PCT/CN2010/075155

§ 371 Date: May 17, 2011

(30) Foreign Application Priority Data
Jul. 21, 2009 (CN) 200910089461.X

(51) Int. Cl. H04B 10/00

(52) U.S. Cl. 398/5

(57) ABSTRACT

Provided is a cross-domain parallel recovering method and system in multi-layer and multi-domain distributed optical network (MMDON). Based on inter-domain LRA (Link Recovery Algorithm), the routing devices establish inter-domain WP (Work Path) and then build inter-domain RP (Recovery Path) based on WP. Inter-domain RPs will be established by using PSM (Parallel Signaling Mechanism) when link failure occurs on inter-domain WPs. That realizes the establishments and of inter-domain RP, and improves the survivability of inter-domain services. Inter-domain RPs are established or engaged before the establishing of WPs, while the intra-domain paths are established after the failure testing. This mechanism ensures the availability of inter-domain resources during recovery and avoids resource waste caused by pre-establishing intra-domain RPs. Moreover, parallel signaling mechanism can decrease the recovery time, and can handle inter-domain link failures simultaneously to avoid queue-waiting.

### FIELD OF THE INVENTION

The present invention relates to a cross-domain recovering method and system in multi-layer and multi-domain optical network, which belongs to distributed optical network field.

### BACKGROUND OF THE INVENTION

Nowadays, with OTN (Optical Transfer Network) evolving towards a more capable, integrated and intelligent direction, the structure of optical network is correspondingly divided into different domains based on management, survivability and technology characters, for example, the network of different network operators is divided into separate domains. Either Service-oriented Architecture, or User-Oriented Architecture, is brought out to deal with issues caused by the growth of large scale, high bandwidth and real-time service such as data mirroring, grid computing and data LAN, as well as the increasing interaction between domains. Inter-domain switching increases the logical hierarchy of network, which makes routing and resource allocation more complicated, and requires higher network performance and security. Therefore, how to solve survivability problem of inter-domain services becomes more and more urgent.

International standards organizations, such as IETF (The Internet Engineering Task Force), OIF (Optical Internetworking Forum) and ITU-T (International Telecommunication Union Telecommunication Standardization Organization) are extending the standards for inter-domain protection and recovery. Routing is the key issue to ensure inter-domain survivability, because the primary problem of protection and restoration is to establish link-irrelevant Label Switched Path (LSP). Control information of different domains is distributed within this domain, and only a part of the information is distributed among different domains. The mentioned parts of information includes inter-domain topology information, accessibility information of inter-domain messages, selection information of inter-domain protection and restoration algorithms, Shared Risk Link Group (SRLG), wavelength fiber information and so on. The distribution of routing information requires a secure, efficient, scalable, stable routing protocol, using layering, converging, abstract summarizing, and business equalization algorithm, which distributes network information promptly and increases the availability of network resources. Currently, inter-domain routing has not achieved a unified standard. To solve the routing and signaling problems in multi-layer and multi-domain optical network, OIF defines hierarchical routing which is based on Traffic Engineering Extensions to Open Shortest Path First (OSPF). IETF defines OSPF-TE Link State Advertisements (LSA) for SONET/SDH, based on GMPLS protocol, allowing traffic engineering databases (TEDBs) to store using information such as wavelength, time slot, SRLG and so on. Moreover, inter-domain protection and restoration is related to position of inter-domain faults and notification of fault messages, requiring extended protocol to implement. IETF is extending the Link Management Protocol (LMP) to locate inter-domain faults, meanwhile, extending RSVP-TE and OSPF-TE to notify inter-domain faults and distribute fault messages. By now, the development work is still incomplete and requires further researches.

Large scale distributed concurrent events and wide range resource scheduling is provided in multi-layer and multi-domain distributed optical network (MMDON). For inter-domain faults in transfer, the speed of restore becomes a vital bottleneck. Because the connection is across multiple domains, the number of nodes passed by is further more than that of a single domain. At present, for inter-domain connections, intra-domain channel is commonly used to restore intra-domain faults, and in this way, the faults could be restored immediately and the fault messages are transferred in this domain. For inter-domain faults, RSVP-TE is used to notify the first node of LSP and end to end method is called to restore WPs. To build an inter-domain LSP from source node to the destination node, a link-irrelevant protection path (PP) is needed. This requires that each domain has many edge nodes to ensure that the link-irrelevant path can be established, and end to end protection requires inter-domain coordination. It takes much time to restore faults across many domains, and it is hard for network resources planning. In addition, it has not been achieved to establish end to end channel recovery among different devices. When link fault occurs, each operation could only ensure protection and restoration within their area, but cannot realize restoration across the whole network. Circuit across different equipment manufactures' ENNI has not achieved a unified protection and restoration. Therefore, the protection methods should be gradually transformed into protection and restoration for local inter-domain link, to reduce the mass messages exchanged across domain and restoration time.

On the other hand, the network control structure is also a key point affecting the protection and restoration time. When there are many concurrent distributed services existed, global managements for parallel inter-domain link faults concurrently should be taken, not just limited to single business. In traditional centralized network control structure, a central control system maintains whole network's database and restores faults. In that case, restoration of concurrent inter-domain faults is restricted by information updating and CPU processing, consuming more time and performing a bad scalability. However, parallel network control mechanism based on distributed control plane could individually handle inter-domain link faults efficiently, without waiting processing of the previous failure which can shorten the recovery time. Routing protocol based on distributed control plane only do real-time update of local information network databases and the abstract aggregation of whole network. It is flexible and efficient to establish new recovery path (RP) by taking advantage of distributed routing method to determine the inter-domain routing. For example, IETF solve path computing problem by configuring Path Computation Element (PCE) in large scale multi-domain network, which means multiple PCEs cooperating to compute the path. Nevertheless, a centralized approach may result in poor performance of routing, so it needs pre-calculated or pro-configured route to make recovery time less than 1 s.

### SUMMARY OF THE INVENTION

The present invention provides a method and system to restore parallel cross-domain faults in multi-layer multi-domain distributed optical network (MMDON).

To achieve the above purpose of the invention, technology schemes are designed as follows:

A method to restore parallel cross-domain faults in MMDON, the method compromising:
A. Establishing loose inter-domain recovery paths (RPs) between adjacent domains among working paths (WPs) on routing devices when establishing WPs for links that span multiple recovery domains and call for a service recovery.
   The inter-domain loose recovery paths (LRPs) claimed are the recovery paths that connect local domain and downstream domain. They are calculated in due manners: according to the link-state information provided by inter-domain flow database, and in the premises that downstream domains which are adjacent to local domains along the working paths are abstracted into target nodes, open shortest path first(OSPF) algorithm and topology method are utilized for the calculation.
B. Realizing parallel cross-domain path recovery based on MMDON in due process: When a fault is detected on the inter-domain links, an inter-domain LRP establishing operation is called by the original domain of failing links to inform domains that pass through the inter-domain LRP. In the mean while, a parallel mechanism to build up LRPs is called.
A. The routing devices claimed consist of routing control and routing management parts, among which the routing control part consists of the inter-domain paths computing unit (PCU), the intra-domain PCU, the inter-domain signaling routing module (SRM), the intra-domain SRM and the message processing unit (MPU). The former four parts claimed are in connection separately with the MPU claimed. And the routing management part includes inter-domain link monitoring module (LMM) which connect to MPU.

The intra-domain SRM claimed further consists of interconnected inter-domain recovery path signaling module (RPSM) and inter-domain working path signaling module (WPSM).

Procedure A includes following sub steps:

A1. For source domain of any inter-domain WPs, when the MPU of the routing devices receives inter-domain WP establishment signals, it passes the signals to inter-domain RPSM in order to establish the inter-domain RP. The inter-domain RPSM then gets the inter-domain LRP between local domain and downstream domain based on link recovery paths algorithm and generates inter-domain RP establishment signals. These signals then transfer to the protection domain along the inter-domain LRPs.

A2. The MPU outside the protection domain will pass the path establishment signals to the inter-domain RPSM. The RPSM then checks the destination of this inter-domain LRP. If the result is a local address, processing will be continued; if not, configuration messages of local edge nodes will be output and certain resources will be reserved. After receiving the reply from the control layer, inter-domain RP establishment signals will be transferred to downstream domain along inter-domain LRPs.

A3. The routing devices of the destination domain in the inter-domain LRPs will output the configuration messages of local edge nodes to reserve resources according to received inter-domain recovery path establishment signals. It then receive the reply messages from control layer and form a success massage of establishing the RP and revert this message to adjacent domain.

A4. After nodes in adjacent domain receive the success message and complete the resources configuration for RP in local domain, new inter-domain RP establishment success messages will be formed and transferred to adjacent domains. Finally, this message will arrive at the original domain where the recovery path is oriented.

A5. When the original domain of the inter-domain RP receives this success message and completes the resource configuration of RR inter-domain RPs from local domain to downstream domain are confirmed to be established.

After the resource reversal for inter-domain LRP is completed, the calculation for inter-domain LRP and resource reversal will be continued among next two adjacent domains until the requests for WPs establishment is completed between resource address and destination address for original purpose, in circumstances that there're still cross-domain paths to be established to serve original purpose. The scheme of un-reserved resources for inter-domain LRPs, i.e., when inter-domain RP establishment signals are transferred along inter-domain LRPs, the resources of edge nodes are reserved but not selected.

The scheme of reserved resources for inter-domain LRPs, i.e., when inter-domain RP establishment signals are transferred along inter-domain LRPs, the resources of edge nodes are reserved and selected, but not required to be cross-connected.

Step B includes following sub steps:

B1. When fault occurs in some WPs, inter-domain link monitoring module (Inter-domain LMM) will call for an inter-domain RP protection switch request to the original domain of the fail inter-domain links.

B2. The MPU of the original domain sends an inter-domain RP switch signal to the downstream domain after receiving the inter-domain LRP switch request. And then it forms an intra-domain LRP establishment signal according to the exit address of local inter-domain LRP. This intra-domain recovery path establishment signal will then be transferred to Intra-Domain signaling router module (SRM) to boot the process of path establishment.

B3. The downstream domain will check the destination address of the message after receiving the inter-domain RP switch message. If the address is local, following procedures will be proceeded. If not, configuration messages of local edge nodes will be output to establish inter-domain LRPs between local domain and upper stream domain, and inter-domain LRP switch signals will be passed to downstream domain along inter-domain LRP for the downstream domain to establish parallel RPs and form the RPs establishing signals according to the entrance address and the exit address of the inter-domain RP within local domain and passed to signaling router module (SRM) to boot the paths establishment procedures.

B4. After the destination domain of inter-domain LRP receives the inter-domain RP switch signals, configuration messages proceeding with inter-domain path establishment between local domain and upper stream domain will be output. The RPs establishment signals will be formed according to the entrance address and the exit address of the inter-domain RP within local domain and passed to signaling router module (SRM) to boot the paths establishment procedures.

B5. After resource configuration is completed upon control layer, routing devices confirms to complete the intra-domain paths configuration and an acknowledgement message will be passed to the former adjacent domain. When this adjacent domain receives this message, it will wait for the local configuration success message. Only by then will the routing devices be confirmed of the completion of the establishment of local paths and form a new acknowledge message. Then this message will be passed to upper stream along the inter-domain LRP until it gets to the original domain where the request is rooted.

B6. After the original domains which request for path recovery receives the acknowledgement message and complete the establishment of local path, the inter-domain RP is confirmed to be established.

For situations that resources are un-reserved for inter-domain LRPs, inter-domain RP switch signals will choose inter-domain resources along the inter-domain recovery paths and execute path recovery operations accordingly on each edge nodes of inter-domain recovery paths.

For situations that resources are reserved for inter-domain LRPs, path recovery operations will directly be executed on edge nodes of inter-domain RPs.

With the invention, for the connection with service recovery requirements across the multiple recovery domains, the inter-domain service recovery mechanism can be established based on local inter-domain link fault mechanism, to ensure the rapid recovery of inter-domain faults and optimize the use of network resources.

The following drawings specify the concrete the implementation of the invention explicitly, and they could help to understand the technical solution of the invention.

### BRIEF DESCRIPTION OF THE DRAWINGS

FIG. 1 is a diagram showing the structure of routing device in the invention;

FIG. 2 is a diagram showing the computation method based on link recovery path (RP) computing between the adjacent domains in the invention.

FIG. 3 is a signaling flow diagram showing the flow of signaling during the establishment process of the RP in the invention.

FIG. 4 is a flow diagram showing the flow of resource reservation in inter-domain loose recovery path (inter LRP) when the routing device is establishing path in the invention;

FIG. 4 (A) is a flow diagram showing the flow of the process after any inter-domain link's source domain receives the inter-domain work path establishment signaling (inter_Rec_Path);

FIG. 4 (B) is a flow diagram showing the flow of the process after protected domain in inter LRP received the inter-domain recovery path establishment signaling (inter_Rec_Path);

FIG. 5 is a flow diagram showing the flow of establishing the complete RP after some inter-domain link failed in the invention.

FIG. 6 is a diagram showing the process of establishing different RPs parallel in the invention.

### DETAILED DESCRIPTION OF EMBODIMENTS OF THE INVENTION

In the distributed multi-layer multi-domain optical network, the method supporting the protection and recovery of cross-domain link faults owns such following requirements: on the one hand, to establish the protection RP based on local inter-domain link fault, cross-domain signaling is required to take the layered signaling mode, not the single-layer signaling mode whose faults are all recovered by means of point to point; The other, in the parallel distributed control mechanism, the optimization of inter-domain routing algorithm and signaling processes, with the effective implement of the inter-domain coordination, result in reducing the adjustment of network circuit, shortening the time of recovery protection. Due to the link RP algorithm and parallel signaling control mechanism proposed, this invention meets the above requirements very well, and is an effective distributed multi-layer multi-domain network protection and restoration method. The details will be specified as follows.

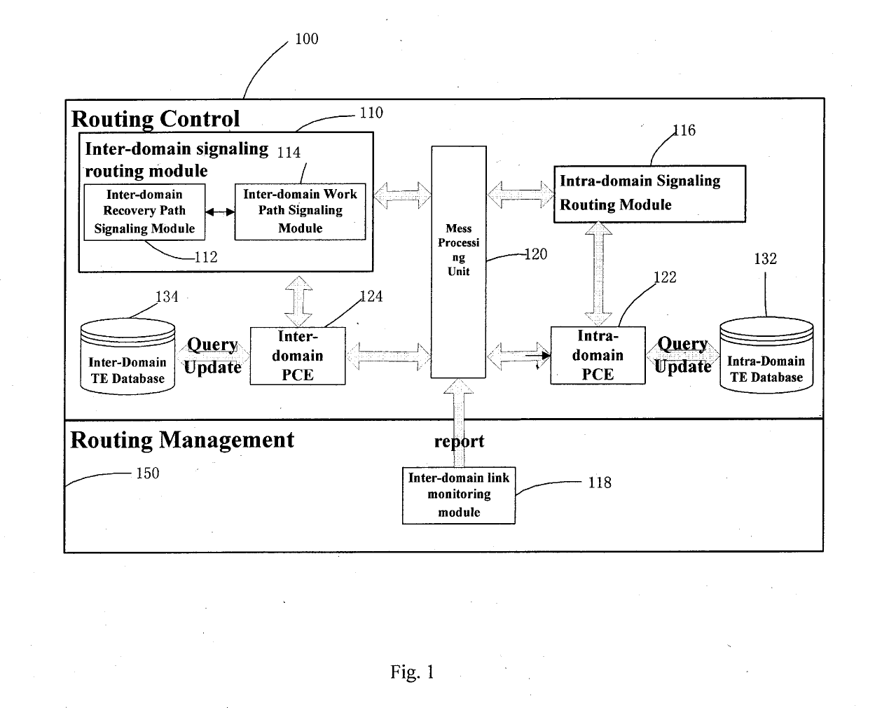

First, the FIG. 1 specifies the basic structure of the routing device provided by the invention. The routing device includes two parts, routing control 100 and routing management 150. In routing control there are intra PCE 124, inter PCE 122, inter-domain signaling routing module (inter SRM) 110 and intra-domain signaling routing module (intra SRM) 116, which are all connected to the message processing unit (MPU) 120 separately; The routing management 150 includes inter-domain link detection module (inter LDM) 118, which connects the MPU 120. Inter SRM 110 further includes inter-domain recovery path signaling module (inter RPSM) 112 and inter-domain work path signaling module (inter WPSM) 114, which are both inter-connected.

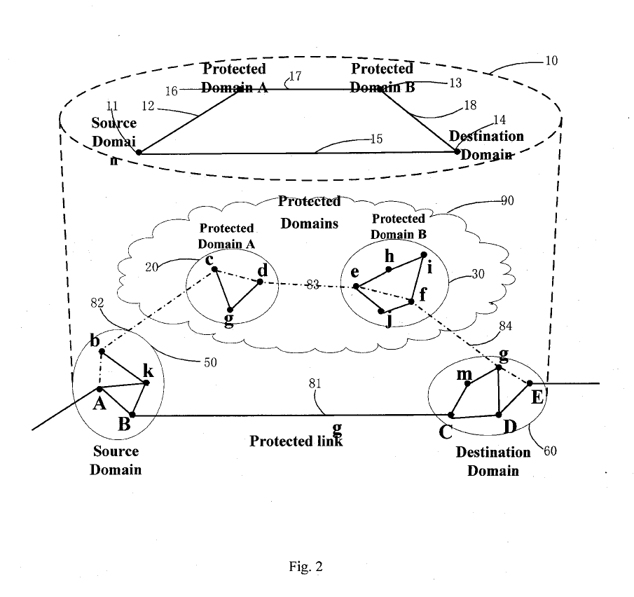

Inter-domain PCE 122: Responsible for computing the loose path (LP) between the source domain and the destination domain, that is saying including the computing of the inter-domain work path (inter WP) and inter LRP. The computing of inter-domain work path (inter LP) should base on the information provided by inter SRM 110, combine the inter-domain traffic engineering database (inter TED) 134, and the loose path (LP) between the source domain and destination domain computed by using Constraint Open Shortest Path First (COSPF) and the topology abstraction method. And then based on the inter TED topology abstraction mapping principle, the import address and the export address of LP in those domains should be detected. The algorithm of computing inter LRP illustrated in FIG. 2 will be specified later.

Intra-domain PCE 124: Responsible for computing the intra-domain feasible path. For intermediate domain, the source address and destination address are determined by the import address and the export address of the LP provided by the intra-domain PCE 124. Then a strictly path between import address and export address is confirmed based on intra TED 134; for destination domain, compute a strictly path from entry address to destiny address.

Inter-domain signaling routing module (inter SRM) 110: including inter-WPSM 114 and inter RPSM 112.

Inter-domain work signaling routing module (inter WSRM) 114: Based on inter WP information in inter-domain work signaling, it handles the signaling of inter-domain path establishment and demolition, and sends the local edge node configuration information to local control procedures to take inter WP establishment and demolition. The inter-domain path information is referred as the feasible path between the customer domain (the domain source address exits) and the destination address computed by the inter SRM 110 based on inter TED 134.

Inter-domain recovery signaling routing module (inter RSRM) 112: Based on inter LRP information in inter-domain recovery signaling, it handles the inter-domain path establishment and demolition, and sends the local edge node configuration information to local control procedures and then take inter-domain work path establishment and demolition. The inter LRP is the one from the domain to downstream domain computed by the inter PCE 124, using inter TED 134 and link RP algorithm between adjacent domains.

Intra-domain signaling routing module (intra SRM) 116: Based on the intra-domain path information in signaling, it handles the intra-domain path establishment and demolition, and sends local control procedures the intra-domain link configuration information to take intra-domain path establishment and demolition. The intra-domain path is the intra-domain up path computed by the intra-domain PCE 122, based on intra TED 132, and its source address and residential address are determined by the LP provided by intra-domain PCE 122.

Inter-domain link detection module (intra LDM) 118: By using the link detection technology, it detects the inter-domain link faults and reports the link state.

Message processing unit (MPU): Responsible for updating the link state database in intra TED 132 based on the link state provided by the intra LDM 118, and reporting information of the TED 132&134 and service request. Then complete the information interaction among the modules and update the network topology information in the routing device.

According to the FIG. 2, The RP algorithm in the invention, based on links in adjacent domains, will be specified as follows.

Apparently there are two layers in FIG. 2, the bottom is a real physical topology while the upper is a logical topology formed with single domain single point topology abstraction method, what should be pointed out here is the inter-domain link in upper 16 17 18 15 is direct mapping from the ones in the bottom 82 83 84 81. In FIG. 2, the WP is A-B-C-D-E, and BC is the inter-domain link.

Protected domain 12&13 or 20&30: Besides the two endpoint domains 11&14 or 50&60 in inter-domain work link, the other domains in the multi-layered multi-domain network can be regarded as the protected domain of the inter-domain link. As the FIG. 2 shows, the protected domain A and the protected domain B are the protected domain of entire link BC.

Protected domains 90: The protected domains Group formed by several protected domains 20&30.

Algorithm of computing inter LRP: Abstractly inter PCE 124 regards the adjacent downstream domain 60 in the WP link as the Destination Node 14, then according to link states in the inter TED 134, The inter LRP from this domain 50 to downstream domain 60 is computed by using the COSPF algorithm and Topology Abstraction Method, what should be paid attention to is that the inter LRP 82 83 84 should not coincide with the loose inter-domain work path. Referring to intra RP, a complete one can be computed by using link state in infra TED 132 and COSPF algorithm, based on export and import address which could be regarded as source and destination address in inter LRP.

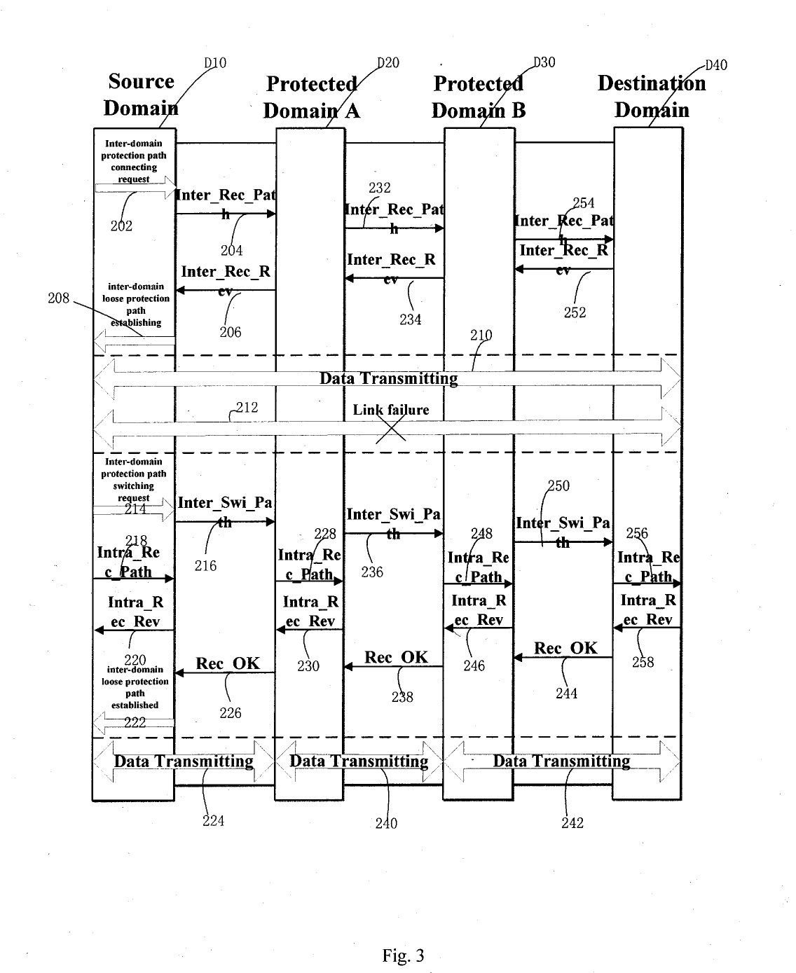

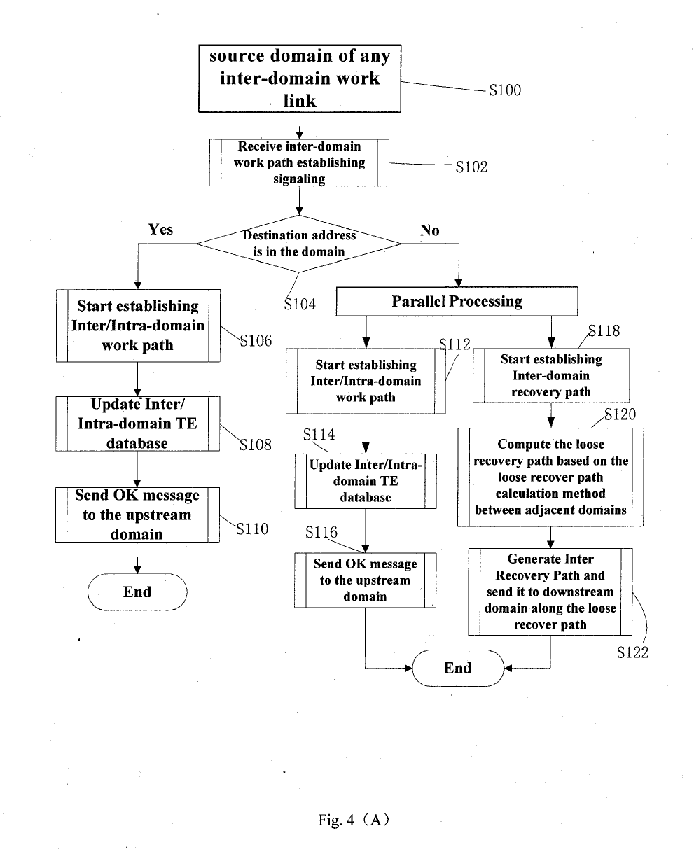

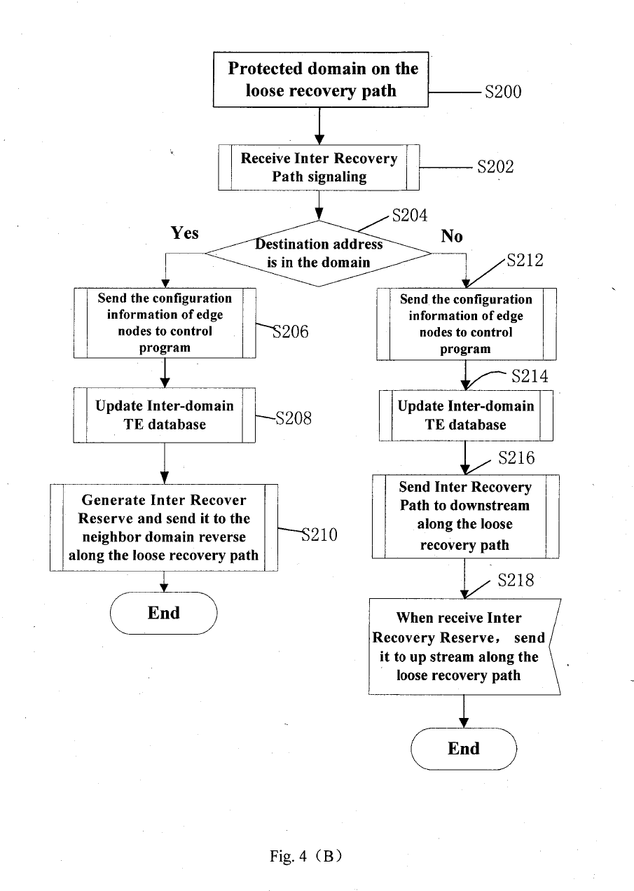

And then, combining the signaling flow diagram in recovery link establishment process (FIG. 3 and FIG. 4), the following will specify how to build RP based on the link faults among the adjacent domains 50&60.

1: Initialization: It mainly includes, collecting and storing the information of inter-domain topology, inter-domain link and edge node capacity into inter TED 134, and the information of intra-domain topology and intra-domain link and node capacity into intra TED 132. For the case that needing to cross the domain when establishing the path, the inter-domain service process should be originated.

2: MPU 114 in customer domain 50 receives the path establishing request, and find the customer's address and the destination address in the task (The destination address mentioned here can be the edge routing address in other domain). Then inter-domain PCE 134 gets the WP link 81 between customer domain 50 and the target domain 60, which contains the information of their edge node and the domain passed through.

3: Based on the inter-domain WP link 81, the inter WPSM 114 would generate an inter WP establishment signaling and pass it downwards, and then complete the establishment of WP.

At the same time, the flow to establish a RP based on link faults among adjacent domains will be specified as follows.

4: After the source domain 50 of any inter-domain link in the inter-domain WP gets the inter-domain work path establishment signaling, it will pass the signaling to the inter RPSM 112, and require to establish inter LRP 202;

5: Inter RPSM 112 will get the inter LRP 81 from this domain D10 e.g. (or 50 in FIG. 2) to the downstream domain D40 (or 60 in FIG. 2), according to the method of computing the RP in adjacent domains. Based on inter LRP link, the inter-domain RP establishment signaling (Inter_Rec_Path) 204 would be generated, which contains LP link information and the signaling type mark. And the Inter_Rec_Path 204 will be passed to the protected domain D20 (or 20 in FIG. 2) along with the inter LRP link.

6: MPU 120 outside the protected domain will pass the signaling to inter RPSM 112, after that inter RPSM 112 will check whether the destination of inter LRP 81 is local or not, if yes, it will be processed further, or a local edge node configuration information will be generated and sent by the local control program to take resource reservation. After receiving the reply from control layer, Inter_Rec_path will be passed downwards along the inter LRP (to D20 then to D40 in FIG. 3 or to 30 to 60 in FIG. 2). Referring to the inter LRP resource reservation mechanism: (1) the resource is not pre-selected. That is to say Inter_Rec_path is passed along the inter LRP, and the resource of edge nod is reserved, but no resource is selected. The inter-domain resources reserved could be private or shared, which can be defined in the local node strategy. The reserved resource might be shared by some different cross-domain WPs or RPs, the network resources should be optimized when ensuring the recovery resource. (2) Resource is pre-selected. This means that Inter_Rec_path is passed along the inter LRP. The resource of edge node is reserved, and inter-domain resource is selected, but there is no cross-connected. The inter-domain resource is set to be private and recovery resource in the selected control layer is fixed, but in the whole recovery path there is no cross-connection.

7. Based on the Inter_Rec_Path 254 it got, the inter LRP destination domain routing device outputs local edge node configuration information to local control program. After receiving the reply from control layer, a successful inter-domain recovery path establishing information (Inter Recover Reserve—Inter_Rec_Rev) 252 will be generated and send to adjacent domain D30 reversely.

8. After the adjacent domain received Inter_Rec_Rev 252, simultaneously completed the domain and inter-domain recovery link configuration, a new Inter_Rec_Rev 234 could be generated and passed to adjacent domain D20 reversely, and keep passing until it reaches the source domain D10 of this RP.

9. The source domains of the RP (all the domains are in inter-domain WP) receive Inter_Rec_Rev 206, and complete the inter-domain recovery link configuration of his own domain, after that, the resource reservation of inter LRP from the domain D10 e.g. (or 50 in FIG. 2) to downstream domain in the WP D40 (or 60 in FIG. 2) should be guaranteed.

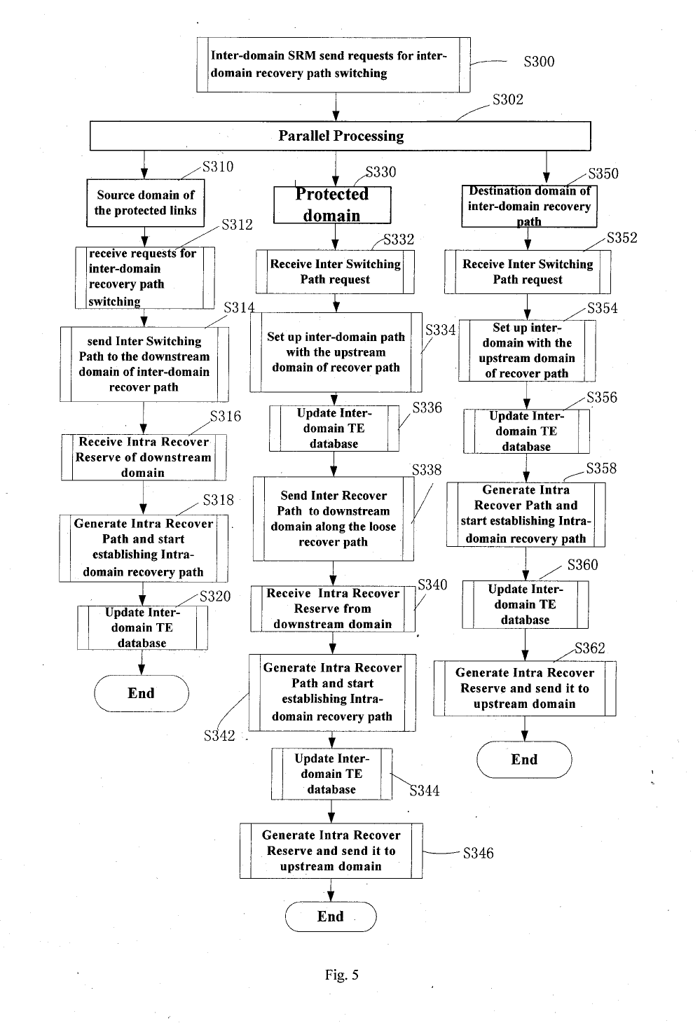

10. As the FIG. 5 shows, when some inter-domain link fails 212, inter LDM 118 should send inter-domain recovery path switching requirement 214 to the source domain the fault link belongs

11. After the external MPU 120 received the inter-domain recovery path switching requirement, the inter-domain recovery path switching signaling (Inter_Swi_Path) 216 will be sent to the downstream domain D20 (for example) in inter LRP. And the intra-domain recovery path establishing signaling (Intra_Rec Path) 228 will be generated and sent to intra SRM 116 based on the export address of inter LRP, and then the intra-domain establishing process will be originated.

12. When inter RPSM 112 of downstream domain D30 in inter LRP receives the Inter_Swi_path 236, it will check whether the destination of inter LRP is local or not. If yes, it will be processed further, or a local edge node configuration information will be generated and sent to the local control program to establish the path between the local domain D30 and the upstream domain D20 in RP, and then the Inter_Swi_Path 250 will be passed to downstream domain D40 along the inter LRP, which can enable the downstream domain D40 to establish the path parallel. At the same time, the Intra_Rec_Path 248 is generated based on the import address and export address of inter LRP, and sent to intra SRM 116 to start the intra-domain path establishment procedure.

For the situation that resources are not being pre-reserved, when a fault is detected on inter-domain links, Inter_Swi_Path would choose inter-domain resources along the recovery routes and execute recovery operations, such as cross connections, for connection reboot in each edge nodes along this recovery routes. As for situations in which resources are pre-reserved, certain recovery operations are directly performed in edge nodes along recovery paths. As for the domains inter LRP pass through, traditional channel recovery modes can be applied as their domain fault recovery mechanism.

13. When inter RSM 112 of the destination domain D40 for the inter LRP receives Inter_Swi_Path 250, it then outputs configuration messages to local edge nodes, and executes inter-domain paths establishments between local domain D40 and upstream domain D30 of the RP. Moreover, it then generates Inter_Rec_Path 256 according to the local domain import address of local inter LRP and the pre-saved export address of inter-domain WPs. Then, these signals are transmitted to inter SRM 116 to boot the process of inter-domain paths establishments.

14. After the controlling program completes the configuration of resource layer, as routing devices acknowledges the completion of configurations of inter-domain paths, an acknowledgement message (Intra_Rec_Rev) 258 is generated, and then being delivered to the upstream neighbor domain D30 along the RP. When the neighbor domain confirms the acknowledgement message, it will wait for a configuration success message from local domain. After the routing devices being acknowledged of the completion of inter-domain paths configurations, an acknowledge message will be generated and continues to be delivered through RPs to upstream domains. The whole process ends when this acknowledgement message arrives at the domain D10 where the initiate requirements of path recovery are called.

15. After domains which require for paths recovery get the acknowledgement messages and complete the establishments of local domain paths, optical paths for inter-domain recovery are confirmed to be established.

This invention is provided with following advantages and effects:
1 In the process of establishing WPs, inter-domain paths of RP has already been established or of which the resource been reserved, making sure of the availability of the resources for recovery and the shortened time for protection switching. In the mean while, resource wastes by the pre-establishment of inter-domain recovery paths can be avoided.
2 When link fault occurred on a certain inter-domain path, only the inter-domain and the intra-domain paths establishing configuration on nodes at each edge of links are called for the original work paths to adjust to establish recovery paths for this link individually. That is to say, recovery paths for different inter-domain links are working independently. So other links of the original work paths are still in use. This shortens the time for protection switching and simplifies configuration process of establishments for inter-domain recovery paths. Moreover, reserved resources for establishment of original work paths are avoided.
3 When switching to recovery paths, parallel signaling mechanism are utilized among each protected domain for inter-domain paths establishments. This mechanism shortens the time needed for a complete recovery of links and thus increases the efficiency.
4 In the situation which parallel services are existed in a large scale, a mechanism of parallel establishments for inter-domain recovery paths can guarantee a quick switching to recovery paths and avoid queue waiting in case those inter-domain link faults for different services occur.

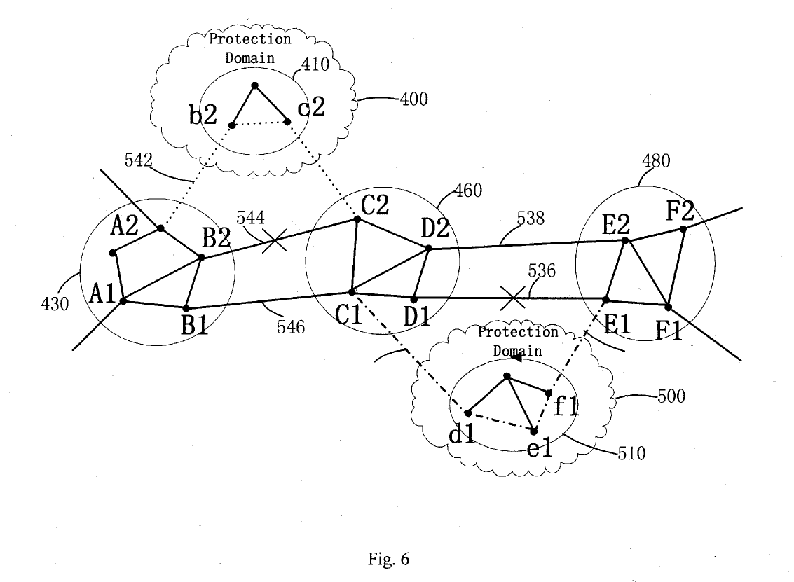

As is shown in FIG. 6, one WP of service 1 is A1-B1-C1-D1-E1-F1, and one of service 2 is A2-B2-C2-D2-E2-F2. When D1-E1 path for service 1 and B2-C2 path for service 2 encounter fault simultaneously, a parallel mechanism for RPs establishing and service recovering is triggered on both paths. Recovery path for service 1 is C1-D1-F1-E1, while that for service 2 is A2-B2-C2, thus shortening the time for a complete recovery and increasing efficiency.

Statements above represent a detailed illustration of methods and system for parallel inter-domain path recovery based on multi-domain distributed optical network provided by this invention. For technology personnel concerned, any obvious change in the premise that goes accord with the essence of this invention, will constitute the invention patent infringement, and bear corresponding legal responsibilities.

1. A method to restore parallel cross-domain faults in multi-layer and multi-domain distributed optical network (MMDON), the method compromising:
A. Establishing loose inter-domain recovery paths (RPs) between adjacent domains among working paths (WPs) on routing devices when establishing WPs for links that span multiple recovery domains and call for a service recovery.
The inter-domain loose recovery paths (LRPs) claimed are the recovery paths that connect local domain and downstream domain. They are calculated in due manners: according to the link-state information provided by inter-domain flow database, and in the premises that downstream domains which are adjacent to local domains along the working paths are abstracted into target nodes, open shortest path first (OSPF) algorithm and topology method are utilized for the calculation.
B. Realizing parallel cross-domain path recovery based on MMDON in due process: When a fault is detected on the inter-domain links, an inter-domain LRP establishing operation is called by the original domain of failing links to inform domains that pass through the inter-domain LRP. In the mean while, a parallel mechanism to build up LRPs is called.

2. A method according to claim 1, which aims at parallel cross-domain path recovery based on multi-domain distributed optical network, has characters as follows:
The routing devices claimed consist of routing control and routing management parts, among which the routing control part consists of the inter-domain paths computing unit (PCU), the intra-domain PCU, the inter-domain signaling routing module (SRM), the intra-domain SRM and the message processing unit (MPU). The former four parts claimed are in connection separately with the MPU claimed. And the routing management part includes inter-domain link monitoring module (LMM) which connect to MPU.

3. A method according to claim 2, which aims at parallel cross-domain path recovery based on multi-domain distributed optical network, has characters as follows:
The intra-domain SRM claimed further consists of interconnected inter-domain recovery path signaling module (RPSM) and inter-domain working path signaling module (WPSM).

4. A method according to claim 3, which aims at parallel cross-domain path recovery based on multi-domain distributed optical network, has characters as follows:
Procedure A includes following sub steps:
A1. For source domain of any inter-domain WPs, when the MPU of the routing devices receives inter-domain WP establishment signals, it passes the signals to inter-domain RPSM in order to establish the inter-domain RP. The inter-domain RPSM then gets the inter-domain LRP between local domain and downstream domain based on link recovery paths algorithm and generates inter-domain RP establishment signals. These signals then transfer to the protection domain along the inter-domain LRPs.
A2. The MPU outside the protection domain will pass the path establishment signals to the inter-domain RPSM. The RPSM then checks the destination of this inter-domain LRP. If the result is a local address, processing will be continued; if not, configuration messages of local edge nodes will be output and certain resources will be reserved. After receiving the reply from the control layer, inter-domain RP establishment signals will be transferred to downstream domain along inter-domain LRPs.
A3. The routing devices of the destination domain in the inter-domain LRPs will output the configuration messages of local edge nodes to reserve resources according to received inter-domain recovery path establishment signals. It then receive the reply messages from control layer and form a success massage of establishing the RP and revert this message to adjacent domain.
A4. After nodes in adjacent domain receive the success message and complete the resources configuration for RP in local domain, new inter-domain RP establishment success messages will be formed and transferred to adjacent domains. Finally, this message will arrive at the original domain where the recovery path is oriented.
A5. When the original domain of the inter-domain RP receives this success message and completes the resource configuration of RP, inter-domain RPs from local domain to downstream domain are confirmed to be established.

5. A method according to claim 4, which aims at parallel cross-domain path recovery based on multi-domain distributed optical network, has characters as follows:
After the resource reversal for inter-domain LRP is completed, the calculation for inter-domain LRP and resource reversal will be continued among next two adjacent domains until the requests for WPs establishment is completed between resource address and destination address for original purpose, in circumstances that there're still cross-domain paths to be established to serve original purpose.

6. A method according to claim 4, which aims at parallel cross-domain path recovery based on multi-domain distributed optical network, has characters as follows:
The scheme of un-reserved resources for inter-domain LRPs, i.e., when inter-domain RP establishment signals are transferred along inter-domain LRPs, the resources of edge nodes are reserved but not selected.

7. A method according to claim 4, which aims at parallel cross-domain path recovery based on multi-domain distributed optical network, has characters as follows:
The scheme of reserved resources for inter-domain LRPs, i.e., when inter-domain RP establishment signals are transferred along inter-domain LRPs, the resources of edge nodes are reserved and selected, but not required to be cross-connected.

8. A method according to claim 3, which aims at parallel cross-domain path recovery based on multi-domain distributed optical network, has characters as follows:
Step B includes following sub steps:
B1. When fault occurs in some WPs, inter-domain link monitoring module (Inter-domain LMM) will call for an inter-domain RP protection switch request to the original domain of the fail inter-domain links.
B2. The MPU of the original domain sends an inter-domain RP switch signal to the downstream domain after receiving the inter-domain LRP switch request. And then it forms an intra-domain LRP establishment signal according to the exit address of local inter-domain LRP. This intra-domain recovery path establishment signal will then be transferred to Intra-Domain signaling router module (SRM) to boot the process of path establishment.
B3. The downstream domain will check the destination address of the message after receiving the inter-domain RP switch message. If the address is local, following procedures will be proceeded. If not, configuration messages of local edge nodes will be output to establish inter-domain LRPs between local domain and upper stream domain, and inter-domain LRP switch signals will be passed to downstream domain along inter-domain LRP for the downstream domain to establish parallel RPs and form the RPs establishing signals according to the entrance address and the exit address of the inter-domain RP within local domain and passed to signaling router module (SRM) to hoot the paths establishment procedures.
B4. After the destination domain of inter-domain LRP receives the inter-domain RP switch signals, configuration messages proceeding with inter-domain path establishment between local domain and upper stream domain will be output. The RPs establishment signals will be formed according to the entrance address and the exit address of the inter-domain RP within local domain and passed to signaling router module (SRM) to boot the paths establishment procedures.
B5. After resource configuration is completed upon control layer, routing devices confirms to complete the intra-domain paths configuration and an acknowledgement message will be passed to the former adjacent domain. When this adjacent domain receives this message, it will wait for the local configuration success message. Only by then will the routing devices be confirmed of the completion of the establishment of local paths and form a new acknowledge message. Then this message will be passed to upper stream along the inter-domain LRP until it gets to the original domain where the request is rooted.
B6. After the original domains which request for path recovery receives the acknowledgement message and complete the establishment of local path, the inter-domain RP is confirmed to be established.

9. A method according to claim 8, which aims at parallel cross-domain path recovery based on multi-domain distributed optical network, has characters as follows:
For situations that resources are un-reserved for inter-domain LRPs, inter-domain RP switch signals will choose inter-domain resources along the inter-domain recovery paths and execute path recovery operations accordingly on each edge nodes of inter-domain recovery paths.

10. A method according to claim 8, which aims at parallel cross-domain path recovery based on multi-domain distributed optical network, has characters as follows:
For situations that resources are reserved for inter-domain LRPs, path recovery operations will directly be executed on edge nodes of inter-domain RPs.
